(19) United States
(12) Patent Application Publication
(10) Pub. No.: US 2025/0341471 A1
(43) Pub. Date: Nov. 6, 2025

(54) Reaction Induced Color-Change Composition

(71) Applicant: Zephyros, Inc., Romeo, MI (US)

(72) Inventors: Kevin Hicks, Romeo, MI (US); Hamid Mortazavian, Romeo, MI (US); Vincent Goldman, Romeo, MI (US); Michael Czaplicki, Romeo, MI (US); Donald Paquet, Troy, MI (US)

(21) Appl. No.: 18/699,470

(22) PCT Filed: Oct. 31, 2022
(86) PCT No.: PCT/US2022/048349

§ 371 Date: Apr. 8, 2024

Related U.S. Application Data
(60) Provisional application No. 63/273,598, filed on Oct. 29, 2021.

(51) Int. Cl. G01N 21/80; C08G 59/32; C08G 59/40; C08L 63/00

(52) U.S. Cl. CPC G01N 21/80; C08G 59/3227; C08G 59/4071; C08L 63/00

(57) ABSTRACT

A color-changing two-part system for indicating proper mixing. The two-part system comprises a A-side and a B-side. The A-side and/or B-side comprises a reactive color-change agent (e.g., a pH sensitive dye). The B-side comprises one or more acids.

### FIELD

The present disclosure relates to a two-part system comprising an A-side and a B-side, particularly a two-part system comprising a reactive color-change agent, which changes color after mixing the A-side and the B-side. The two-part system may be advantageous to indicate, by a color change, proper mixing, curing, and/or foaming of the A-side and the B-side.

### BACKGROUND

Two-part systems are typically provided as an A-side and a B-side. The two-part systems are typically mixed prior to use. Mixing of the A-side and the B-side typically initiates curing and/or foaming of the system.

Proper mixing is a concern with two-part systems. If the two-part system is not mixed properly then it may not cure and/or foam properly. Since they are mixed in the field, prolonged mechanical mixing with a blending device may not be possible. Moreover, mechanical mixing may be prone to defects of static mixers or human error. Improper mixing may be detrimental to downstream applications. For example, the reaction product of a two-part system employed for structural foam may not provide sufficient intended mechanical properties; or if foaming is desired, the reaction product may not have a volume of expansion to suitably fill a space.

It may be desirable to provide an indicator of proper mixing to ensure proper curing and/or foaming of the two-part system.

It may be desirable to provide a two-part system that indicates proper mixing thereof.

It may be desirable to provide a two-part system that provides a simple and clearly understandable indicator of proper mixing.

It may be desirable to provide a reliable and repeatable measure of proper mixing.

It may be desirable to provide a two-part system comprising an indicator that is inexpensive.

It may be desirable to provide a two-part system that indicates proper mixing rapidly.

It may be desirable to provide a two-part system that includes a quality control measure incorporated into the composition.

### SUMMARY

The present disclosure relates to a color-changing two-part system. The color-changing two-part system may address at least some of the needs identified above. The color-changing two-part system may comprise a A-side, and a B-side comprising one or more acids. A non-reactive color-change agent may be present in the A-side and/or the B-side. A reactive color-change agent may be present in the A-side. Non-reactive color-change agents and/or reactive color-change agents may be present in the two-part system.

The reactive color-change agent may include an aniline derivative. The reactive color-change agent may include a 4,4′-methylenedianiline derivative. The reactive color-change agent may be epoxidized. The reactive color-change agent may be 4,4′-methylenedianiline tetra-glycidyl ether.

The reactive color-change agent may be present in the A-side in an amount of between about 0.1% and 30%, more preferably between about 1% and 25%, or even more preferably between about 5% and 20%, by weight of the A-side.

The non-reactive color-change agent may be pH sensitive. The non-reactive color-change agent provided in the A-side may include Cresol Red, Crystal Violet, or both. The non-reactive color-change agent provided in the B-side may include Bromocresol Green.

The non-reactive color-change agent may be present in the A-side in an amount of between about 0.05% and 5%, more preferably between about 0.1% and 3%, or even more preferably between about 1% and 2%, by weight of the A-side.

The non-reactive color-change agent may be present in the B-side in an amount of between about 0.05% and 5%, more preferably between about 0.1% and 3%, or even more preferably between about 1% and 2%, by weight of the B-side.

The A-side may comprise one or more additional epoxy resins which may include one or more multifunctional aromatic epoxy resins, multifunctional aliphatic epoxy resins, epoxy novolac resins, silane modified epoxy resins, or any combination thereof.

The one or more additional epoxy resins may be present in an amount of between about 50% and 80%, more preferably between about 55% and 75%, or even more preferably between about 60% and 70%, by weight of the A-side.

The silane modified epoxy resent may be present in an amount of between about 0.5% and 10%, more preferably between about 1% and 9%, or even more preferably between about 2% and 8%, by weight of the A-side.

The epoxy novolac resin may include both one or more liquid epoxy novolac resins and one or more solid epoxy novolac resins.

The A-side may comprise one or more additives. The one or more additives may include one or more metal carbonates, minerals, reinforcing fibers, hydrophobic silica, core-shell particulate polymers, pigments, or any combination thereof.

The metal carbonate may include an ultra-fine calcium carbonate, a fine calcium carbonate, a medium-fine calcium carbonate, a medium calcium carbonate, a coarse calcium carbonate, or any combination thereof. The two-part system, after mixing the A-side and the B-side, may expand (foam) to a volume of between about 10% and 800%, more preferably between about 50% and 700%, or even more preferably between about 100% and 600% of the original unexpanded (un-foamed) volume of the A-side and the B-side.

The A-side may consist essentially of the reactive color-change agent.

The one or more acids may comprise at least one or more phosphate esters. The one or more acids may optionally include phosphoric acid, citric acid, acetic acid, other acidic phosphorous compounds, any acid that is stable with phosphoric acid or phosphate ester, or any combination thereof. The one or more phosphate esters may include cashew nut shell liquid-based phosphate esters, 2-ethylhexyl glycidyl ether-based phosphate esters, phenyl glycidyl ether-based phosphate esters, or any combination thereof.

The phosphate ester may be present in the B-side in an amount of between about 40% and 95%, more preferably between about 50% and 80%, or even more preferably between about 60% and 70%, by weight of the B-side.

The optional phosphoric acid, citric acid, acetic acid, other acidic phosphorous compounds, any acid that is stable with phosphoric acid or phosphate ester, or any combination thereof may be present in the B-side in an amount of between about 4% and 18%, more preferably between about 6% and 16%, or even more preferably between about 8% and 14%, by weight of the B-side.

A ratio of the phosphate ester to the reactive color-change agent may be between about 85:1 and 2.5:1, more preferably between about 80:1 and 5:1, more preferably between about 70:1 and 10:1, or even more preferably between about 60:1 and 20:1.

The B-side may comprise one or more additives. The one or more additives may include one or more metal carbonates, minerals, reinforcing fibers, hydrophobic silica, core-shell particulate polymers, pigments, or any combination thereof.

The two-part composition may be a thermoset.

A color of the mixed A-side and B-side is not an expected color from a mixture of the original color of the A-side and the original color of the B-side.

The teachings herein are further directed to a two-part system selected from two-part adhesives and two-part sealants. Said two-part system comprising an A-side and a B-side wherein the A-side and the B-side are separated from one another, wherein upon mixing of the A-side with the B-side the resultant mixture develops a color, or tone, or visual indicator which differs from that of the A-side and the B-side. The B-side comprises one or more acids, wherein (i) the A-side comprises a first pH sensitive dye having at least one functional group selected from the group consisting of epoxy, amino, hydroxyl, methyl, carbonyl, carboxyl, and phosphate; (ii) the A-side and/or the B-side comprises a second pH sensitive dye differing from the first pH sensitive dye, preferably not having said at least one functional group; or both (i) and (ii).

### BRIEF DESCRIPTION OF THE DRAWINGS

FIG. 1 is a photograph of samples set forth in Table 1.

FIG. 2 is a photograph of foamed samples.

FIG. 3 illustrates a graph showing the relationship between time to peak exotherm and percent YDM in the A-side.

FIG. 4 illustrates a graph showing the relationship between peak exotherm temperature and percent YDM in the A-side.

FIG. 5 illustrates a graph showing the relationship between time to peak exotherm and percent H₃PO₄ in the B-side.

FIG. 6 illustrates a graph showing the relationship between peak exotherm temperature and percent H₃PO₄ in the B-side.

FIG. 7 illustrates a graph showing the relationship between lap shear peak stress and percent YDM.

FIG. 8 illustrates a photograph of samples set forth in Table 3.

FIG. 9 illustrates a photograph of samples set forth in Table 4.

### DETAILED DESCRIPTION

The present teachings meet one or more of the above needs by the improved two-part composition described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the filing date of U.S. Provisional Application Ser. No. 63/273,598, filed Oct. 29, 2021, the contents of that application being fully incorporated herein in its entirety for all purposes.

International Publication Nos. WO 2020/101732 A1, WO 2020/205355 A1, WO 2020/206346 A1, and WO 2020/198139 A1 illustrate the use of phosphoric acid and phosphate esters for cure-in-place compositions. These compositions are typically employed for a wide range of room-temperature activated systems, such as rigid structural foams, cavity filling, gaskets, and sealants. The benefits of such compositions may include the ability to adhere to a variety of substrates, the inclusion of low volatility organic compounds (VOC's), not being sensitive to the dispensing temperature, not being sensitive to the exact mixing ratio of a two-part system, the ability to tune physical and mechanical properties, or any combination thereof. These compositions do not provide an indicator of proper mixing and thus proper curing and/or foaming.

The composition of the present teachings may be a two-part composition (“two-part system”). The two-part system may comprise an A-side and a B-side. The A-side and the B-side may be mixed to form a mixed composition. The mixed composition may cure to form a reaction product. The reaction product may be completely cured (i.e., undergoing no further cross-linking reactions). Curing may initiate after mixing the A-side and the B-side. Curing may initiate generally immediately upon mixing the A-side and the B-side. Curing may be delayed for a time after mixing the A-side and the B-side. The two-part system may be free of latent curing agents, curing accelerators, or both.

The two-part system may be mixed at a temperature of about 0° C. to 50° C. Curing of the two-part system may activate at room temperature (i.e., about 18° C. to about 25° C.). Volume expansion, if desired, may increase with increasing the temperature of the mixed composition and/or the temperature of the A-side and/or the B-side at the time of mixing. Ambient temperature may not affect foaming rate as much as the temperature of the two-part system at the time of dispensing. Ambient temperature, as referred to herein, may mean the temperature of the environment in which the two-part system is present.

The two-part system may form a thermoset.

The two-part system may be employed in automotive, aerospace, construction, repair shop, home maintenance, other similar industries, or any combination thereof. The two-part system may be employed as an adhesive, a composite material matrix resin, a structural foam, a cavity filler, a structural reinforcement, a sealing material, or any combination thereof. The adhesive may adhere similar and/or dissimilar substrates.

The two-part composition system of the present teachings may be dispensed. The dispensing may be performed by dispensing equipment. The dispensing may be performed by automated or non-automated dispensing equipment. The dispensing may be performed by pneumatic or manual systems. The two-part composition may be mixed manually, without using a cartridge or dispensing equipment. The manually mixed two-part composition may be poured onto a substrate or into a cavity.

### A-Side

The A-side may comprise one or more reactive and/or non-reactive color-change agents, additional epoxy resins (i.e., chemical compositions with one or more reactive epoxide groups), reactive diluents, additives, or any combination thereof. The reactive diluents and/or additives may be optional. The A-side may consist essentially of one or more reactive and/or non-reactive color-change agents.

The reactive color-change agent may be a material that is pH sensitive such that the change in color occurs in response to change in the pH of the environment in which the material is located. The reactive color-change agent may be a pH sensitive dye. The reactive color-change agent may include aniline and/or derivatives selected from chloroanlines, methylanilines, and chloromethylanilines. The aniline derivative may be selected from N-Metdylaniline, 2,5-Dimetdoxyaniline, 2-Acetyl-phenotdiazine, 3-Chloro-2-metdylaniline, 3-Chloro-4-metdylaniline, 3-Chloroaniline, 4-Chloro-3-amino benzo trifluoride, 5-Chloro-2-amino benzo trifluoride, 5-Chloro-2-metdylanilin, Chloroanilin, Chlorodimetdoxyaniline, Dehydrotdio toluidine, Dichloroaniline, Dimetdylaniline, Meta toluidine, o-Chloro-p-nitroaniline, Para toluidine, Phenotdiazine, or Phenylenediamine, The aniline may include methylenedianiline (MDA) and/or derivatives thereof. The reactive color-change agent may be epoxidized. The reactive color-change agent may react to become a part of the cured system. The delaying of polymerization, delaying of foaming activation, improvement of adhesion of the two-part composition to substrates, or any combination thereof may result from the epoxidizing of the reactive color-change agent. The reactive color-change agent may include 4,4′-methylenedianiline tetra-glycidyl ether, as shown below.

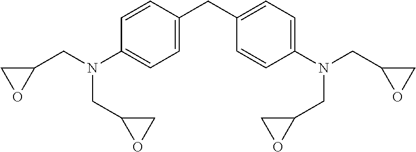 [SMILES: c1cc(N(CC2CO2)CC2CO2)ccc1Cc1ccc(N(CC2CO2)CC2CO2)cc1]

The non-reactive color-change agent may be present in A-side. Non-reactive, as referred to herein, may mean that the material does not undergo or contribute to a polymerization reaction. That is, the non-reactive color-change agent may not become a part of the polymer chain resulting from mixing of the A-side and the B-side. The non-reactive color-change agent may be pH sensitive. The color of the non-reactive color-change agent may depend on the pH of the mixture. The color of the non-reactive color-change agent may change as pH changes. The pH of the A-side according to the present disclosure may be about 5 to 10. The pH of the B-side may be less than 7 or even less than 5. The pH of the combined A-side and B-side may be less than the pH of the A-side alone due to the acidic component of the B-side. The pH of the combined A-side and B-side may be less than 8, less than 7, or even less than 5. The particular non-reactive color-change agent selected may depend on the pH of the A-side prior to mixing with the B-side and the pH of the combined A-side and B-side.

The reactive color-change agent and the non-reactive color change agent may be collectively referred to herein as “color-change agent”.

Any suitable non-reactive color-change agent may be employed in the system of the present disclosure if it is compatible with the chemistry of the A-side, it changes color as pH reduces from the starting pH range of the A-side, and if the color transition pH of the non-reactive color-change agent cooperates with the pH variation from A-side to the final product (i.e., the mixed A-side and B-side). The non-reactive color-change may include, but is not limited to, Cresol Red, Crystal Violet, the like, or any combination thereof.

The non-reactive color-change agent may be present in the A-side in an amount of about 0.05% or more, 1% or more, or even 2% or more, by weight of the A-side. The non-reactive color-change agent may be present in the A-side in an amount of about 5% or less, 4% or less, or even 3% or less, by weight of the A-side.

The reactive color-change agent and/or non-reactive color change agent may change color upon mixing of the A-side and the B-side. The color change may activate generally immediately upon adequately mixing the A-side and the B-side. That is, the color change may activate about 3 minutes or less after mixing, more preferably about 1 minute or less after mixing, more preferably about 30 seconds or less after mixing, or even more preferably about 5 seconds or less after mixing. The color change may be delayed for a time after mixing the A-side and the B-side. The delay may be for about 5 minutes or more, 10 minutes or more, or even 20 minutes or more. The delay may be for about 2 hours or less, 1 hour or less, or even 30 minutes or less. The A-side and B-side may mix upon being dispensed. By way of example, the A-side and B-side may flow through a static mixer. The color change may provide a visual verification of the quality of mixing and curing.

The color change may occur when the A-side and the B-side are mixed sufficiently. The color change may remain stable after curing. That is, the hue, saturation, and/or value of the reaction product may not change appreciably over time (e.g., the color will not change in wavelength by more than 5%) if the reaction product is stored in an environment below about 150° C., more preferably 120° C., or even more preferably 100° C., and/or free of ultraviolet light exposure.

Hue, as referred to herein, may mean the primary color (red, green, blue), secondary color (cyan, magenta, yellow), or any mixture thereof. For example, the reaction product may be blue in color or hue.

Saturation, as referred to herein, may mean the chromic purity with one end of the saturation range being white and the other end of the saturation being a pure hue.

Value, as referred to herein, may mean the lightness or darkness of a hue with one end of the value range being black and the other end of the value range having an absence of black.

Color may be defined by hue, saturation, and value.

The A-side may have a natural initial color prior to mixing with the B-side. The natural color may be tan or white, in absence of any pigment. The B-side may have a natural initial color prior to mixing with the A-side. The natural color may be brown. The mixed composition and/or reaction product may have a color that is different from the color of the A-side and/or the B-side. The mixed composition and/or reaction product may have an unexpected color. For example, while the mixture of two tan components may be expected to be tan but it may actually be blue.

The color of the mixed composition and/or reaction product may be blue, dark blue, tan, gray, or yellow. While these colors are provided by the exemplary formulations presented herein, other colors are within the scope of the present teachings. The color of the mixed composition and/or reaction product may be stable at room temperature (i.e., about 18° C. to about 25° C.). The color of the mixed composition and/or reaction product may become darker at elevated temperatures. That is the value of the mixed composition and/or reaction product may change at elevated temperatures. The degree of color change may be a function of the temperature. By way of example, the color may change to light brown, brown, or even dark brown. The color change of the material exposed to a particular elevated temperature may be stable unless and until the material is exposed to a higher temperature.

The mixed composition may have a color that changes over time until the reaction product is formed. The mixed composition may have a color that changes until a particular extent of cure is achieved. The color change may cease when the mixed composition has cured by about 60% or more, 70% or more, 80% or more, or even 90% or more.

The reactive color-change agent and/or non-reactive color change agent may be employed with or in the absence of a pigment. The pigment may be provided in the A-side, the B-side, or both. The pigment may be distinct from the reactive color-change agent. The reactive color-change agent may perform its intended indicator function even in the presence of a pigment. The reactive color-change agent may be selected and provided in sufficient amount to cooperate with a pigment to provide a pre-determined final color. By way of example, a reactive color-change agent may be selected and employed in an amount to provide the reaction product with a particular hue, saturation, and value and a pigment may be selected and employed in an amount to modify the hue, saturation, and/or value of the reaction product. For example, for a reaction product that is blue, red pigment may be added to produce a reaction product that is purple.

The pigment may include white pigment. The white pigment may modify the saturation of the reaction product color. The reactive color-change agent may be selected and provided in sufficient amount to achieve a desired color of the reaction product without the inclusion of a pigment.

The final color may not be an expected color when mixing the two colors of the A-side and the B-side. For example, one would expect the final color of a white A-side and a brown B-side to produce a mixed composition or reaction product that is tan but rather the mixed composition or reaction product of the present teachings may be blue. The unexpected color may be particularly advantageous to assist users determine whether proper mixing has occurred. By way of example, some individuals may not detect subtle color changes and so a color change from brown to yellow may be easier to detect by some individuals as compared to a color change from brown to a slightly different hue of brown.

Users may determine that proper mixing, curing, and/or foaming did not occur if the natural (original) colors of the A-side and/or B-side remain generally unchanged. The natural colors of the A-side and/or B-side may be present as areas or streaks in the reaction product. Users may determine that proper mixing, curing, and/or foaming did not occur if the reaction product or portions thereof do not have a pre-determined color. For example, while a color change may occur, the hue, saturation, and/or value may be different from the desired hue, saturation, and/or value of the reaction product.

The reactive color-change agent may provide for the identification of unmixed or under-mixed reaction product or even portions of the reaction product. For example, static mixers may not have a requisite number of mixing elements to properly mix the two-part system. As another example, one of the A-side or B-side may surge through a static mixer prior to the other. This is particularly likely to occur for the first material dispensed from a filled cartridge set and static mix nozzle. This may result from differing viscosities of the two components, air pockets in the dispenser, defective static mixers, damaged static mixers, or any combination thereof.

The B-side may comprise an acid, as discussed herein. An epoxidized aniline ring of the reactive color-change agent may open in a reaction with the acid. The acid may protonate the aniline groups. Without intending to be bound by theory, protonation of the aniline groups may be the reason for reduction in crosslink density and color change.

Ionization of non-reactive color-change agents may occur with the acid of the B-side. Ionization may cause the non-reactive color-change agents to change color.

Epoxy ring opening, protonation of aniline groups, and/or pH change may be performed with acids such as phosphoric acid, citric acid, acetic acid, other acidic phosphorous compounds, any acid that is stable with phosphoric acid or phosphate ester, or any combination thereof. Other acids are contemplated by the present disclosure.

The reactive color-change agent may be present in an amount of about 0.1% or more, 1% or more, 5% or more, or even 10% or more, by weight of the A-side. The reactive color-change agent may be present in an amount of about 30% or less, 25% or less, 20% or less, or even 15% or less, by weight of the A-side. The saturation of the color generated by the reactive color-change agent may be increased by increasing the amount of the reactive color-change agent in the A-side.

The reactive color-change agent may not appreciably affect foaming of the mixed composition, where the amount of the reactive color-change agent in the A-side is less than 8%. That is, where the amount of reactive color-change agent in the A-side is less than 8%, the difference in volume expansion of the mixed composition may be about 10% or less, more preferably about 5% or less, or even more preferably about 1% or less, as compared to a mixed composition that is free of the reactive color-change agent.

The reactive color-change agent may function to indicate proper mixing, improve ductility of the composition, delay polymerization, delay foaming activation, improve adhesion of the two-part composition to substrates, or any combination thereof. The reactive color-change agent may provide other useful and tunable properties.

The reactive color-change agent may improve the ductility and/or strain to failure of the composition. Without intending to be bound by theory, this may be due to changes in the crosslink density and the ratio of open to closed cells of foam. The ductility improvement may depend on the amount of the reactive color-change agent provided in the A-side.

Without intending to be bound by theory, the use of the reactive color-change agent may increase the pH of the A-side, and therefore the pH of the mixed composition upon mixing the A-side and B-side. The reduced acidity may result in reduced crosslink density of the final product and/or reduced reaction rate. The peak temperature of the exothermic reaction may indicate the degree of crosslink density. That is, the cross-linking may generate heat.

The reactive color-change agent may delay curing and/or foaming activation, modulate working time, modulate cure time, or any combination thereof. Without intending to be bound by theory, the reactive color-change agent may increase the pH of the A-side and therefore the mixed composition may have a reduced acidity. The delay in activation, working time, cure time, or any combination thereof may increase by increasing the amount of the reactive color-change agent.

An increased delay in activation, increased working time, increased cure time, or any combination thereof may be advantageous for certain applications where the user needs longer assembly time.

Delaying the activation may mean increasing the open time. The open time may refer to the time before significant curing reaction occurs. The delay of cure activation of the two-part system could be about 1 minute or more, 5 minutes or more, 10 minutes or more, or even 30 minutes or more. The delay of cure activation of the two-part system could be about 4 hours or less, 3 hours or less, 2 hours or less, or even 1 hour or less. The delay may be particularly useful in non-foaming compositions that tend to cure faster.

The open time may increase as the ratio of the reactive color-change agent in the formulation increases. The open time may decrease with increasing the viscosity of the dispensed A-side and B-side. The open time may decrease with increasing the volume of the dispensed A-side and B-side. The open time may decrease with increasing the temperature.

Adhesion of the mixed composition to substrates may be best during the open time. Wettability of substrates by the mixed composition may be best during the open time. Adhesion and/or wettability may be indicated by lap-shear testing. Adhesion and/or wettability may be indicated by failure mode. Particularly, a change from an adhesive failure mode to cohesive failure mode, or vice versa.

Working time may refer to the time it takes the mixed composition to no longer bond to a substrate.

Cure time may refer to the time it takes the mixed composition to fully cure. The peak temperature of the exothermic reaction may indicate the overall cure time. That is, while the composition cures, the composition may undergo both a heat generation as a result of the exothermic reaction and a heat loss with the atmosphere and/or substrate on which the composition is disposed. Thus, a higher peak temperature of the exothermic reaction may indicate that the overall cure time is less as the exothermic reaction provides more heat to the composition at a rate that is faster than the rate at which heat is shed to the atmosphere or substrate upon which the composition is disposed. The cure time may be about 1 minute or more, 5 minutes or more, 10 minutes or more, 30 minutes or more, or even 1 hour or more. The cure time may be about 48 hours or less, 24 hours or less, 12 hours or less, 6 hours or less, or even 3 hours or less.

The reactive color-change agent may have an epoxy equivalent weight of about 90 g/eq to 140 g/eq, more preferably 100 g/eq to 130 g/eq, or even more preferably 111 g/eq to 117 g/eq, according to ASTM D1652-11. The reactive color-change agent may have a viscosity, measured at 25° C., of about 2,000 cP to 8,000 cP, more preferably 2,500 cP to 7,000 cP, or even more preferably 3,000 cP to 6,000 cP, according to ASTM D445-21. A non-limiting example of a suitable reactive color-change agent may include Epotec® YDM 441, commercially available from Aditya Birla Chemicals.

The A-side may include one or more additional epoxy resins. The additional epoxy resins may include multifunctional aromatic epoxy resins, multifunctional aliphatic epoxy resins, silane modified epoxy resins, epoxy/elastomer adducts, or any combination thereof.

The additional epoxy resin may be present in the A-side in an amount of about 50% or more, 55% or more, or even 60% or more, by weight of the A-side. The additional epoxy resin may be present in the A-side in an amount of about 80% or less, 75% or less, or even 70% or less, by weight of the A-side.

Providing the A-side with one or more additional epoxy resins may delay the reaction time and therefore increase the working time of the composition.

The two-part system may include one or more multifunctional aromatic and/or aliphatic epoxy resins. The multifunctional aromatic and/or aliphatic epoxy resins may increase the crosslink density of the reaction product, improve mechanical properties of the reaction product, improve chemical resistance of the reaction product, reduce the viscosity of the two-part system and/or mixed composition, improve the cell structure quality of a foamed reaction product, or any combination thereof. The functionality of the multifunctional aromatic and/or aliphatic resin may be about 2.1 or more, 3 or more, or even 4 or more. The functionality of the multifunctional aromatic and/or aliphatic resin may be about 8 or less, 7 or less, or even 6 or less.

Where the two-part system includes metal carbonate in the A-side, effective functionality of the B-side may be partially reduced when combined with the A-side in the mixed composition. This may be due to reaction of the acid of the B-side with the metal carbonates of the A-side to cause foaming. The A-side may include components with increased functionality to compensate for a reduced functionality of the B-side that results from the metal carbonate reaction. The A-side may be formulated with increased functionality by using reactive ingredients with functionality higher than 2 such as aliphatic multifunctional epoxy resins.

The stiffness of the reaction product may be reduced as a result of including the reactive color-change agent in the two-part system. Multifunctional epoxy resins may be employed to compensate for the reduced stiffness.

Examples of suitable multifunctional resins may include, but are not limited to, epoxidized sorbitol, epoxidized soybean oil, solid epoxy novolac resins, liquid epoxy novolac resins, or any combination thereof.

The multifunctional aliphatic epoxy resin may have an epoxy equivalent weight of about 130 g/eq to 230 g/eq, more preferably about 140 g/eq to 220 g/eq, or even more preferably about 160 g/eq to 195 g/eq, according to ASTM D1652-11. The multifunctional aliphatic epoxy resin may have a viscosity, measured at 25° C., of about 6,000 cP to about 20,000 cP, more preferably about 7,000 cP to 19,000 cP, or even more preferably about 8,000 cP to 18,000 cP, according to ASTM D445-21. The multifunctional aliphatic epoxy resin may include an epoxidized sorbitol. A non-limiting example of a suitable multifunctional aliphatic epoxy resin may include Erisys® GE 60, commercially available from Huntsman Advanced Materials.

The multifunctional aromatic epoxy resin may include a reaction product of epichlorohydrin and bisphenol A. The additional epoxy resin may be a liquid epoxy resin. The additional epoxy resin may have an epoxy equivalent weight of about 160 g/eq to 210 g/eq, more preferably about 170 g/eq to 200 g/eq, or even more preferably about 182 g/eq to 192 g/eq, according to ASTM D1652-11. The additional epoxy resin may have a viscosity, measured at 25° C., of about 9,000 cP to 16,000 cP, more preferably about 10,000 cP to 15,000 cP, or even more preferably about 11,000 cP to 14,000 cP, according to ASTM D445-21. A non-limiting example of a suitable difunctional aromatic epoxy resin may include D.E.R.™ 331™ commercially available from Olin Corporation.

The two-part system may include one or more epoxy novolac resins. The epoxy novolac resin may be liquid or solid at room temperature (i.e., about 18° C. to about 25° C.). The two-part system may include one or more liquid epoxy novolac resins, one or more solid epoxy novolac resins, or both. The epoxy novolac resin may have a functionality of about 2.1 to 6.5. The epoxy novolac resin may function to improve crosslink density, improve glass transition temperature, improve mechanical properties, improve chemical resistance, improve moisture resistance, or any combination thereof of the reaction product. Greater amounts of epoxy novolac resins could be used to compensate for some of the possible stiffness (i.e., elastic modulus) reduction that may result from addition of reactive color-change agents. Higher functionality the epoxy novolac resins could be used to improve the stiffness of the composition to compensate for possible stiffness reduction due to the presence of reactive color-change agents. Selection of epoxy novolac resin may depend on the desired viscosity, mechanical properties, and chemical resistance for the reaction product.

The one or more epoxy novolac resins may be present in an amount of about 1% or more, 5% or more, 10% or more, or even 15% or more, by weight of the A-side. The one or more epoxy novolac resins may be present in an amount of about 50% or less, 40% or less, 30% or less, or even 20% or less, by weight of the A-side.

The polymeric solid epoxy novolac resin may have an epoxy equivalent weight of about 175 g/eq to 250 g/eq, more preferably about 185 g/eq to 240 g/eq, or even more preferably about 195 g/eq to 230 g/eq, according to ASTM D1652-11. The polymeric solid epoxy novolac resin may have a viscosity, measured at 25° C., of about 1 P to 80 P, more preferably about 5 P to 70 P, or even more preferably about 10 P to 60 P, according to ASTM D445-21. A non-limiting example of a suitable polymeric solid epoxy novolac resin may include Epon™ SU-8, commercially available from Hexion.

The liquid epoxy novolac resin may have an average functionality of about 1.5 to 4, more preferably 2 to 3.5, more preferably about 2.5 to 3, or even more preferably about 2.65. The liquid epoxy novolac resin may have an epoxy equivalent weight of about 130 g/eq to 200 g/eq, more preferably about 145 g/eq to 185 g/eq, or even more preferably about 165 g/eq to 178 g/eq, according to ASTM D1652-11. The liquid epoxy novolac resin may have a viscosity, measured at 25° C., of about 10,000 cP to 40,000 cP, more preferably about 15,000 cP to 30,000 cP, or even more preferably about 18,000 cP to 28,000 cP, according to ASTM D445-21. A non-limiting example of a suitable liquid epoxy novolac resin may include Epalloy® 8250, commercially available from Huntsman Advanced Materials.

The liquid epoxy novolac resin may be a reaction product of epichlorohydrin and phenol-formaldehyde novolac. The epoxy phenol novolac resin may have an epoxy equivalent weight of about 145 g/eq to 195 g/eq, more preferably 155 g/eq to 185 g/eq, or even more preferably 164 g/eq to 177 g/eq, according to ASTM D1652-11. The epoxy phenol novolac resin may have a viscosity, measured at 25° C., of about 16,000 cP to 25,000 cP, more preferably 17,000 cP to 24,000 cP, or even more preferably 18,000 cP to 23,000 cP, according to ASTM D445-21. A non-limiting example of a suitable liquid epoxy novolac resin may include D.E.N.™ 426, commercially available from Olin Epoxy.

The two-part system may include one or more silane modified epoxy resins. The silane modified epoxy resin may function to impart improved adhesion of the reaction product. The adhesion may be to glass, metal, or both. The silane groups may form covalent bonds with epoxy resins and inorganic substrates. The silane modified epoxy resin may be present in the A-side. The silane modified epoxy resin may be present in an amount of about 0.5% or more, 1% or more, 2% or more, or even 3% or more, by weight of the A-side. The silane modified epoxy resin may be present in an amount of about 10% or less, 9% or less, 8% or less, or even 7% or less, by weight of the A-side.

The silane modified epoxy resin may have an epoxy equivalent weight of about 170 g/eq to 240 g/eq, more preferably about 180 g/eq to 230 g/eq, or even more preferably about 190 g/eq to 220 g/eq, according to ASTM D1652-11. The silane modified epoxy resin may have a viscosity, measured at 25° C., of about 7,000 cP to 17,000 cP, more preferably about 8,000 cP to 16,000 cP, or even more preferably about 9,000 cP to 15,000 cP. A non-limiting example of a suitable silane modified epoxy resin may include Epokukdo KSR 177, commercially available from Kukdo Chemical Co., Ltd.

The two-part system may include one or more epoxy/elastomer adducts. The epoxy/elastomer adduct may be included to impart a plasticization effect to the two-part system; and/or modify structural properties of the two-part system such as strength, strain-to-failure, fracture toughness (Glc), peel, adhesion durability, uncured-material integrity (i.e., less likely to stick, break or deform before use), and stiffness. Carboxyl-terminated butadiene-acrylonitrile may be particularly useful for developing adhesion to contaminated surfaces. The contaminated surfaces may include stamping lubricants typical to the automotive industry.

The elastomer in the adduct may be selected from polysulfide, polybutadiene, polyisoprene, polyisobutylene, isoprene-butadiene copolymer, neoprene, acrylic, natural rubber, carboxyl-terminated butadiene-acrylonitrile, polysiloxane, polyester, urethane prepolymer, nitrile rubber (e.g., a butyl nitrile, such as carboxy-terminated butyl nitrile), butyl rubber, polysulfide elastomer, acrylic elastomer, acrylonitrile elastomers, silicone rubber, polyester rubber, diisocyanate-linked condensation elastomer, styrene butadiene rubber, ethylene-propylene diene rubbers, chlorosulfonated polyethylene, fluorinated hydrocarbons, or any combination thereof. The epoxy/elastomer adduct may include a carboxyl-terminated polymer (e.g., an adducted carboxyl-terminated polymer, an adducted carboxy-terminated butyl nitrile). The epoxy/elastomer adduct may be a dicarboxylic acid. The elastomer compound suitable for the adduct may be a thermosetting elastomer, although not required.

Examples of additional or alternative epoxy/elastomer or other adducts suitable for use in the present teachings are disclosed in United States Patent Publication No. 2004/0204551 A1 and International Publication No. 2020/033393 A1.

The adduct itself generally includes about 1:5 to 5:1 parts of epoxy to elastomer, and more preferably about 1:3 to 3:1 parts of epoxy to elastomer. More typically, the adduct includes at least about 10%, more typically at least about 20% and or even at least about 30% elastomer and also typically includes not greater than about 60%, although higher or lower percentages are possible.

The epoxy/elastomer adduct may be present in the A-side. The epoxy/elastomer adduct may be present in an amount of about 1% or more, 5% or more, 10% or more, or even 15% or more by weight of the A-side. The epoxy/elastomer adduct may be present in an amount of about 35% or less, 30% or less, 25% or less, or even 20% or less, by weight of the A-side.

The epoxy/elastomer adduct may be a combination of two or more different adducts. The adducts may include solid adducts, liquid adducts, or semisolids at room temperature (i.e., about 18° C. to about 25° C.) or may also be some combination thereof. The adduct may comprise substantially entirely (i.e., at least 70%, 80%, 90% or more) of one or more adducts that are solid at room temperature.

The A-side may include one or more additives. The one or more additives may include metal carbonates, minerals, reinforcing fibers, hydrophobic silica, core-shell particulate particles, pigment, or any combination thereof.

The two-part system may foam due to the presence of one or more metal carbonates in the two-part system. The metal carbonate may react with an acid. The metal carbonate may be provided in the A-side. The acid may be provided in the B-side. The metal carbonate may include calcium carbonate. The calcium carbonate may be provided in one or more different particle sizes. Many combinations of calcium carbonate particle sizes can be utilized.

The metal carbonate may be provided as a combination of fine and a medium-fine size calcium carbonate. The fine calcium carbonate may provide a uniform and fine cell structure. The combination of fine and medium-fine size calcium carbonates may provide a balance between the foaming and curing and thus structural integrity of the foam.

The reaction product may have a volume expansion of about 10% or more, 50% or more, 100% or more, or even 200% or more. The reaction product may have a volume expansion of about 800% or less, 700% or less, 600% or less, or even 500% or less.

The color saturation of the reaction product decreases with increasing the foaming. That is, as the reaction product foams to a larger volume expansion, the color becomes lighter. The color change could be used as an indicator to monitor when and if the foaming and curing is completed and whether acceptable foaming had occurred.

Foaming may begin before complete cure of the reaction product. The foaming time of the mixed composition may be about 30 seconds or more, 1 minute or more 5 minutes or more, or even 10 minutes or more. The foaming time of the mixed composition may be about 2 hours or less, 1 hour or less, or even 30 minutes or less. The foaming time may be the time frame within which the two-part system actively foams.

The calcium carbonate may include an ultra-fine particle size calcium carbonate. The ultra-fine particle size may be about 1 micron to 3 micron, or even more preferably about 2 microns. A non-limiting example of a suitable ultra-fine calcium carbonate may include Hubercarb® Q2, commercially available from Huber Engineered Materials.

The calcium carbonate may include a medium fine particle size calcium carbonate. The medium fine particle size may be about 20 microns to 24 microns, or even more preferably about 22 microns. A non-limiting example of a suitable medium fine particle size calcium carbonate may include Hubercarb® Q200, medium fine, commercially available from Huber Engineered Materials.

The calcium carbonate may include a medium fine particle size calcium carbonate. The medium fine particle size may be about 10 microns to 16 microns, or even more preferably about 13 microns. A non-limiting example of a suitable ultra-fine calcium carbonate may include Hubercarb® Q325, commercially available from Huber Engineered Materials.

The calcium carbonate may include a coarse particle size calcium carbonate. The coarse particle size may be about 200 microns to 800 microns, 300 microns to 700 microns, or even 400 microns to 600 microns. A non-limiting example of a suitable ultra-fine calcium carbonate may include Hubercarb® Q40-200, commercially available from Huber Engineered Materials.

The mineral may include one or more silicate minerals. The silicate mineral may include one or more inosilicates. The inosilicate may include wollastonite. Wollastonite may improve mechanical strength, durability, adhesion, moisture resistance, impact resistance, or any combination thereof. The external shape of an individual crystal or crystal group of the one or more minerals may be acicular. Wollastonite may contain embedded metal carbonates that contribute to foaming. The acicular structure of the mineral with aspect ratios in the range of 9 to 20 may help to improve mechanical strength and durability of the reaction product. Non-limiting examples of suitable wollastonite may include NYGLOS® 12 and NYGLOS® 8, commercially available from NYCO Minerals Inc.; and Vansil® HR2000, commercially available from Vanderbilt Minerals, LLC.

Non-limiting examples of suitable hydrophobic silica may include AEROSIL® R 202 commercially available from Evonik Corporation; and CAB-O-SIL® TS-530 and TS-720, commercially available from Cabot Corporation.

An organophilic phyllosilicate may be used in place of a hydrophobic silica. An example of a suitable organophilic phyllosilicate may include Garamite-1958, commercially available from BYK-Chemie GmbH.

The two-part system may comprise one or more core-shell particulate polymers. The core-shell particulate polymer may function to improve the fracture toughness and ductility of the reaction product. Epoxy resin formulations are usually known for applications that require rigidity and high temperature resistance. Epoxies tend to be brittle. There are different strategies to reduce the brittleness of the epoxies. Often, tougheners such as core-shell polymers particles are used to reduce the brittleness and improve the fracture toughness of the reaction product without affecting the temperature resistance significantly.

The core-shell particulate polymer may be present in the A-side, B-side, or both. The core-shell particulate polymer may be present in an amount of about 5% or more, 10% or more, or even 15% or more, by weight of the A-side or B-side. The core-shell particulate polymer may be present in an amount of about 35% or less, 30% or less, or even 25% or less, by weight of the A-side or B-side.

The core-shell particulate polymer may be pre-blended with and dispersed in an epoxy resin. The core-shell particulate polymer may be dispersed in a bisphenol A-based epoxy resin. The epoxy resin may be a liquid epoxy resin. The epoxy resin may have a viscosity, measured at 50° C., of about 16,000 cP to about 20,000 cP, more preferably 17,000 cP to 19,000 cP, or even more preferably about 18,000 cP, according to ASTM D445-21. The core-shell particulate polymer may be present in the epoxy resin in an amount of about 30% to 45%, more preferably 35% to 40%, or even more preferably about 37%. The core-shell particulate polymer may have a median particle size of about 100 nm to 300 nm, or even about 200 nm. The core-shell particulate polymer may comprise polybutadiene. Non-limiting examples of suitable core-shell particulate polymers may include Kane Ace MX-257 and MX-267, commercially available from Kaneka Corporation.

### B-Side

The B-side may comprise one or more acids, acid anhydrides, additional epoxy resin reaction products, reactive diluent reaction products, additives, non-reactive color-change agents, or any combination thereof. The additional epoxy resin reaction products and/or reactive diluent reaction products may be optional. The B-side may consist essentially of one or more acids.

The B-side may comprise one or more acids. The acid may be liquid at room temperature. Room temperature, as referred to herein, may mean a temperature of between about 18° C. to about 25° C. The acid may have a pH of less than 7. The acid may comprise phosphate ester, phosphoric acid, citric acid, acetic acid, or any combination thereof. The acid may comprise at least phosphate ester and optionally phosphoric acid, citric acid, acetic acid, other acidic phosphorous compounds, any acid that is stable with phosphoric acid or phosphate ester, or any combination thereof. The acid that is stable with phosphoric acid or phosphate ester may not affect the shelf stability when mixed with phosphoric acid or phosphate ester. The acid may react with the reactive color-change agent. The reaction with the reactive color-change agent may provide color change to the mixed composition and reaction product. The pH of the acid may influence the color of the non-reactive color change agent.

The acid may contribute to foaming of the two-part system.

The working time of the mixed composition may be tuned by the selection of the acid. Employing phosphate esters instead of phosphoric acid may delay the curing reaction, due to their higher pH, lower functionality, higher viscosity, or any combination thereof. The functionality and pH of phosphate esters may be selected to tune the working time.

The B-side may comprise one or more phosphate esters. The phosphate ester may be a reaction product of a mono-epoxide (“phosphate ester precursor”) with phosphoric acid, as shown below

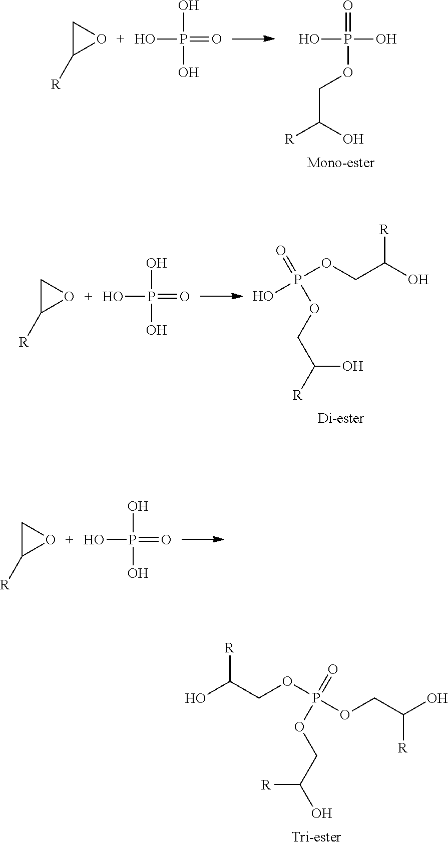

The phosphate esters may include a phosphate ester derived from cashew nut shell liquid (CNSL). The cashew nut shell liquid may be epoxidized. The epoxidized cashew nut shell liquid may be a reaction product of one or more components of cashew nut shell liquid and epichlorohydrin. The one or more components of cashew nut shell liquid may include anacardic acid, cardanol, cardol, or any combination thereof with an aliphatic C10-C20 moiety. The aliphatic C10-C20 moiety may be saturated or unsaturated. The aliphatic C10-C20 moiety may be hydrophobic. The phosphate ester may be a reaction product of epoxidized cashew nut shell liquid and phosphoric acid, as shown below:

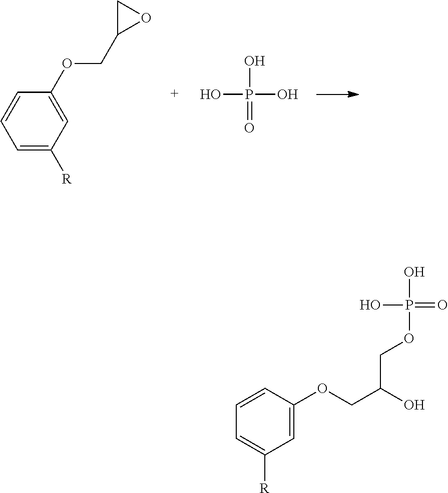

A cardanol-based cashew nut shell liquid is illustrated above but other components of cashew nut shell liquid are contemplated by the present disclosure. A non-limiting example of a suitable epoxidized cashew nut shell liquid may include Cardolite® LITE 2513HP, commercially available from Cardolite Corporation, Monmouth Junction NJ.

The phosphate esters may include a phosphate ester derived from 2-ethylhexyl glycidyl ether. The phosphate ester may be an isomer of a reaction product of 2-ethylhexyl glycidyl ether and phosphoric acid, as shown below:

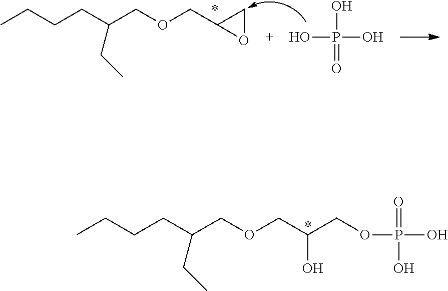 [SMILES: CCCCC(CC)COCC1CO1 ; O=P(O)(O)O ; CCCCC(CC)COCC(O)COP(=O)(O)O]

The above reaction may produce an isomer with the hydroxide group depending from the α carbon and an isomer with the hydroxide group depending from the β carbon.

A non-limiting example of a suitable 2-ethylhexyl glycidyl ether may include ERISYS® GE-6, commercially available from CVC Thermoset Specialties, Moorestown, NJ.

The phosphate esters may include a phosphate ester derived from phenyl glycidyl ether. A non-limiting example of a suitable phenyl glycidyl ether may include ERISYS® GE-13, commercially available from CVC Thermoset Specialties, Moorestown, NJ.

The phosphate esters may be produced by the reaction of phosphoric acid and/or polyphosphoric acid and/or phosphoric anhydride and/or phosphoryl chloride with various alcohols (“phosphate ester precursors”).

The B-side may comprise one or more phosphate esters, phosphate ester precursors, or both. The one or more phosphate esters may be pre-reacted. The B-side may comprise one or more phosphate ester precursors that may be combined with phosphoric acid prior to combination with the A-side.

The phosphate esters may be produced by a reaction of a range of stoichiometric ratios of phosphate ester precursors to phosphoric acid. The one or more phosphate esters may be produced by a reaction, in a ratio of phosphate ester precursor to phosphoric acid, of about 0.6:1 to 1:0.6, more preferably about 0.7:1 to 1:0.7, or even more preferably about 0.8:1 to 1:0.8. The phosphate ester may be present in an amount of about 40% or more, 50% or more, or even 60% or more, by weight of the B-side. The phosphate ester may be present in an amount of about 95% or less, 80% or less, or even 70% or less, by weight of the B-side.

The phosphoric acid, citric acid, acetic acid, other acidic phosphorous compounds, any acid that is stable with phosphoric acid or phosphate ester, or any combination thereof may be present in the B-side in an amount of about 4% or more, 6% or more, or even 8% or more, by weight of the B-side. The phosphoric acid, citric acid, acetic acid, other acidic phosphorous compounds, any acid that is stable with phosphoric acid or phosphate ester, or any combination thereof may be present in the B-side in an amount of about 18% or less, 16% or less, or even 14% or less, by weight of the B-side.

The B-side may include additional phosphoric acid. The additional phosphoric acid may include ortho-phosphoric acid, polyphosphoric acid, or both. The additional phosphoric acid may increase the crosslink density and reduce the open time. Reaction speed of the pre-reacted phosphate esters may be increased by the addition of the additional phosphoric acid in the B-side. The additional phosphoric acid may increase foaming speed and total foaming volume of the mixed composition.

The ratio of phosphate ester to reactive color-change agent may be between about 85:1 and 2.5:1, more preferably between about 80:1 and 5:1, more preferably between about 70:1 and 10:1, or even more preferably between about 60:1 and 20:1.

The ratio of phosphoric acid, citric acid, acetic acid, other acidic phosphorous compounds, any acid that is stable with phosphoric acid or phosphate ester, or any combination thereof to reactive color-change agent may be between about 0.1:1 and 5:1, more preferably between about 0.5:1 and 4:1, or even more preferably between about 1:1 and 3:1.

The non-reactive color-change agent may be present in B-side. Non-reactive, as referred to herein, may mean that the material does not undergo or contribute to a polymerization reaction. That is, the non-reactive color-change agent may not become a part of the polymer chain resulting from mixing of the A-side and the B-side. The non-reactive color-change agent may be pH sensitive. The color of the non-reactive color-change agent may depend on the pH of the mixture. The pH of the B-side according to the present disclosure may be about 1 to 4. The pH of the combined A-side and B-side may be greater than the pH of the B-side alone due to the relatively higher pH of the A-side. The particular non-reactive color-change agent selected may depend on the pH of the B-side prior to mixing with the A-side and the pH of the combined A-side and B-side.

Any suitable non-reactive color-change agent may be employed in the system of the present disclosure if it is compatible with the chemistry of the B-side, it changes color as pH increases from the starting pH range of the B-side, and if the color transition pH of the non-reactive color-change agent cooperates with the pH variation from B-side to the final product (i.e., the mixed A-side and B-side). The non-reactive color-change may include, but is not limited to, Bromocresol Green, the like, or any combination thereof.

The non-reactive color-change agent may be present in the B-side in an amount of about 0.05% or more, 1% or more, or even 2% or more, by weight of the B-side. The non-reactive color-change agent may be present in the B-side in an amount of about 5% or less, 4% or less, or even 3% or less, by weight of the B-side.

The B-side may include one or more additives. The one or more additives may include minerals, reinforcing fiber, hydrophobic silica, core-shell particulate polymers, or any combination thereof.

The mineral may include wollastonite. Non-limiting examples of suitable wollastonite may include NYGLOS® 12 and NYGLOS® 8, commercially available from NYCO Minerals Inc.; and Vansil® HR2000, commercially available from Vanderbilt Minerals, LLC.

Non-limiting examples of suitable hydrophobic silica may include AEROSIL® R 202 commercially available from Evonik Corporation; and CAB-O-SIL® TS-530 and TS-720, commercially available from Cabot Corporation.

An organophilic phyllosilicate may be used in place of a hydrophobic silica. An example of a suitable organophilic phyllosilicate may include Garamite-1958, commercially available from BYK-Chemie GmbH.

The two-part system may comprise one or more core-shell particulate polymers. The core-shell particulate polymer may function to improve the fracture toughness and ductility of the reaction product. Epoxy resin formulations are usually known for applications that require rigidity and high temperature resistance. Epoxies tend to be brittle. There are different strategies to reduce the brittleness of the epoxies. Often, tougheners such as core-shell polymers particles are used to reduce the brittleness and improve the ductility of the reaction product without affecting the temperature resistance significantly.

The core-shell particulate polymer may be present in the A-side, B-side, or both. The core-shell particulate polymer may be present in an amount of about 5% or more, 10% or more, or even 15% or more, by weight of the A-side or B-side. The core-shell particulate polymer may be present in an amount of about 35% or less, 30% or less, or even 25% or less, by weight of the A-side or B-side.

The core-shell particulate polymer may be pre-blended with and dispersed in an epoxy resin. In this case the core-shell particulate polymer may be utilized in the A-side. The core-shell particulate polymer may be dispersed in a bisphenol A-based epoxy resin. The epoxy resin may be a liquid epoxy resin. The epoxy resin may have a viscosity, measured at 50° C., of about 16,000 cP to about 20,000 cP, more preferably 17,000 cP to 19,000 cP, or even more preferably about 18,000 cP, according to ASTM D445-21. The core-shell particulate polymer may be present in the epoxy resin in an amount of about 30% to 45%, more preferably 35% to 40%, or even more preferably about 37%. The core-shell particulate polymer may have a median particle size of about 100 nm to 300 nm, or even about 200 nm. The core-shell particulate polymer may comprise polybutadiene. Non-limiting examples of suitable core-shell particulate polymers may include Kane Ace MX-257 and MX-267, commercially available from Kaneka Corporation.

The two-part composition may be mixed in a volumetric ratio of the A-side to the B-side. The volumetric ratio of the A-side to the B-side may be about 10:1 to 1:1, or even more preferably about 5:1 to 2:1.

### EXAMPLES

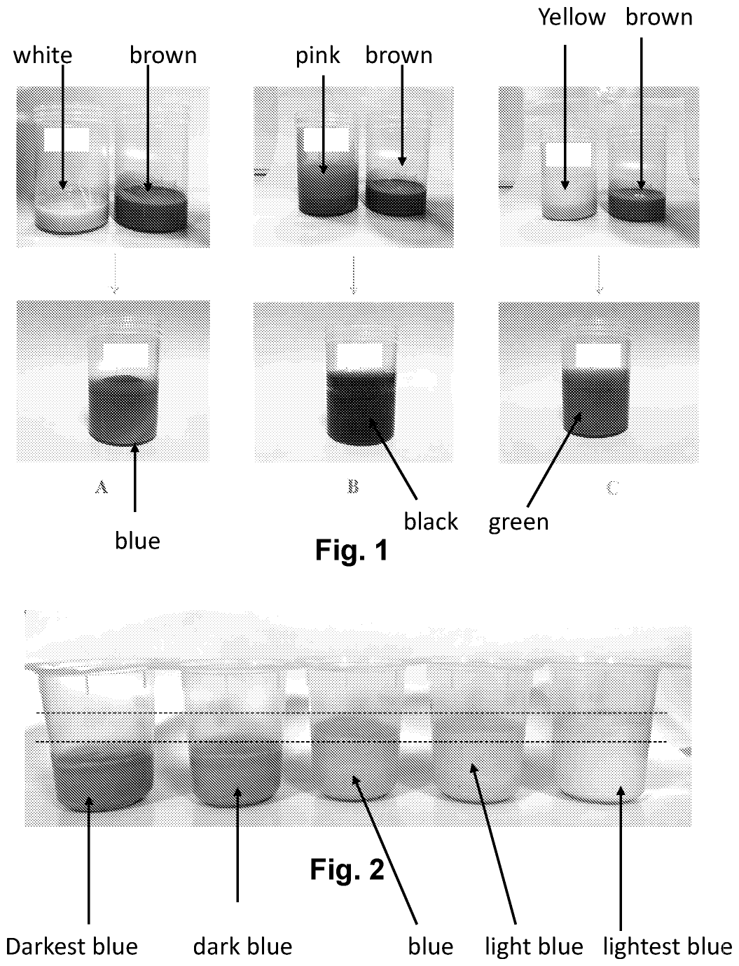

FIG. 1 illustrates the formation of unexpected colors upon mixing the A-side and the B-side, based upon the original colors of the A-side and B-side. In column A, the A-side (left) is white, and the B-side (right) is brown and mixing of the two provides for a reaction product that is blue. At least one expected color produced from white, and brown may be tan. In column B, the A-side (left) is magenta, and the B-side (right) is brown and mixing of the two provides for a reaction product that is purple. At least one expected color produced from magenta, and brown may be garnet. In column C, the A-side (left) is yellow, and the B-side (right) is brown and mixing of the two provides for a reaction product that is green. At least one expected color produced from yellow, and brown may be a lighter shade of brown.

FIG. 2 illustrates the lightening of color (saturation reduction) produced by increasingly higher volume expansion produced by foaming. The mixed composition is blue and lighter shades of blue result from increasingly higher volumes of expansion. Dashed reference lines are provided to better illustrate the volume expansion. The composition is expanded (foamed) to a higher volume expansion from left to right. Each of the samples contain the same amount of reactive color-change agent.

Table 1 shows various formulations with different ratios of the reactive color-change agent, Epotec® YDM 441. The ratio may be between the reactive color-change agent and the aggregate of other ingredients of the A-side. All quantities are provided in units of grams.

TABLE 1

| | A | B | C | D | E | F | G | H |
|---|---|---|---|---|---|---|---|---|
| A Side | | | | | | | | |
| D.E.R. ™ 331 ™ | 13.77 | 13.53 | 13.17 | 12.83 | 12.41 | 12.01 | 11.64 | 10.80 |
| Epalloy ® 8250 | 25.71 | 25.25 | 24.58 | 23.95 | 23.16 | 22.42 | 21.72 | 20.16 |
| Epotec ® YDM 441 | 0.00 | 1.80 | 4.39 | 6.84 | 9.93 | 12.81 | 15.52 | 21.60 |
| Erisys ® GE 60 | 12.86 | 12.62 | 12.29 | 11.98 | 11.58 | 11.21 | 10.86 | 10.08 |
| Kane Ace MX-257 | 18.37 | 18.03 | 17.56 | 17.11 | 16.54 | 16.01 | 15.52 | 14.40 |
| Epokukdo KSR 177 | 4.59 | 4.51 | 4.39 | 4.28 | 4.14 | 4.00 | 3.88 | 3.60 |
| Carboxyl-terminated | 2.75 | 2.71 | 2.63 | 2.57 | 2.48 | 2.40 | 2.33 | 2.16 |
| epoxy/elastomer adduct | | | | | | | | |
| Hubercarb ® Q2 | 0.73 | 0.72 | 0.70 | 0.68 | 0.66 | 0.64 | 0.62 | 0.58 |
| Hubercarb ® Q200 | 1.65 | 1.62 | 1.58 | 1.54 | 1.49 | 1.44 | 1.40 | 1.30 |
| CAB-O-SIL ® TS 720 | 1.19 | 1.17 | 1.14 | 1.11 | 1.08 | 1.04 | 1.01 | 0.94 |
| NYGLOS ® 8 | 18.37 | 18.03 | 17.56 | 17.11 | 16.54 | 16.01 | 15.52 | 14.40 |
| Total | 100.00 | 100.00 | 100.00 | 100.00 | 100.00 | 100.00 | 100.00 | 100.00 |
| B Side | | | | | | | | |
| Cashew nut shell liquid- | 15.81 | 15.81 | 15.81 | 15.81 | 15.81 | 15.81 | 15.81 | 15.81 |
| based phosphate ester | | | | | | | | |
| Phenyl glycidyl ether - | 55.34 | 55.34 | 55.34 | 55.34 | 55.34 | 55.34 | 55.34 | 55.34 |
| based phosphate ester | | | | | | | | |
| Vansil ® HR2000 | 18.97 | 18.97 | 18.97 | 18.97 | 18.97 | 18.97 | 18.97 | 18.97 |
| CAB-O-SIL ® TS 720 | 3.56 | 3.56 | 3.56 | 3.56 | 3.56 | 3.56 | 3.56 | 3.56 |
| H3PO4 85% | 6.32 | 6.32 | 6.32 | 6.32 | 6.32 | 6.32 | 6.32 | 6.32 |
| Total | 100.00 | 100.00 | 100.00 | 100.00 | 100.00 | 100.00 | 100.00 | 100.00 |

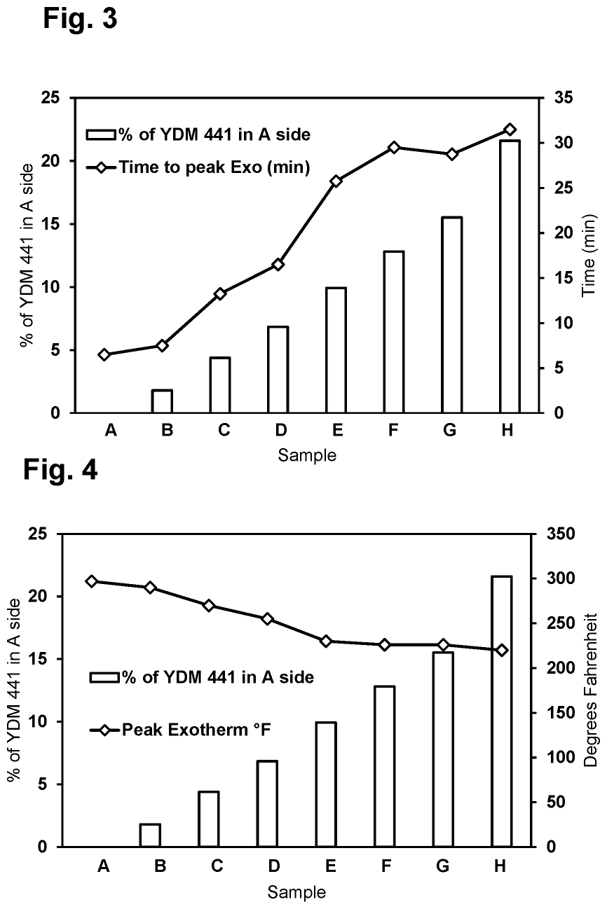

FIG. 3 illustrates a graph. The graph illustrates the relationship of the time it takes the formulations of Table 1 to arrive at the peak temperature of the exothermic reaction as a function of the ratio of reactive color-change agent in the A-side formulation. The time it takes to arrive at the peak temperature of the exothermic reaction generally increases as the ratio of the reactive color-change agent in the A-side formulation increases. Peak temperature of the exothermic reaction was determined consistent with ASTM D2471-99.

FIG. 4 illustrates a graph. The graph illustrates the relationship between the ratio of the reactive color-change agent in the A-side of the formulations of Table 1 and the peak temperature of the exothermic reaction. As the ratio of the reactive color-change agent in the A-side increases, generally the peak temperature of the exothermic reaction decreases. Peak temperature of the exothermic reaction was determined consistent with ASTM D2471-99.

Table 2 shows various formulations with different ratios of the phosphoric acid in the B-side. The ratio may be between the phosphoric acid and the aggregate of other ingredients of the B-side. The ratio of the reactive color-change agent present in the A-side is constant. Increasing the amount of phosphoric acid (H₃PO₄) may compensate for the reduction of crosslink density due to the presence of the reactive color-change agent in the formulation. Increasing the amount of phosphoric acid may improve the mechanical properties of the reaction product while keeping a longer delay of cure activation and/or overall cure time. All quantities are provided in units of grams.

TABLE 2

| | I | J | K |
|---|---|---|---|
| A Side | | | |
| D.E.R. ™ 331 ™ | 11.95 | 11.95 | 11.95 |
| Epalloy ® 8250 | 23.90 | 23.90 | 23.90 |
| Epotec ® YDM 441 | 4.39 | 4.39 | 4.39 |
| Erisys ® GE 60 | 14.34 | 14.34 | 14.34 |
| Kane Ace MX-257 | 15.93 | 15.93 | 15.93 |
| Epokukdo KSR 177 | 3.98 | 3.98 | 3.98 |
| Carboxyl-terminated | 2.39 | 2.39 | 2.39 |
| epoxy/elastomer adduct | | | |
| Hubercarb ® Q2 | 1.59 | 1.59 | 1.59 |
| Hubercarb ® Q200 | 3.19 | 3.19 | 3.19 |
| CAB-O-SIL ® TS 720 | 0.80 | 0.80 | 0.80 |
| Vansil ® HR2000 | 17.53 | 17.53 | 17.53 |
| Total | 100.00 | 100.00 | 100.00 |
| B Side | | | |
| Cashew nut shell liquid- | 13.53 | 12.95 | 12.41 |
| based phosphate ester | | | |
| Phenyl glycidyl ether - | 54.14 | 51.80 | 49.66 |
| based phosphate ester | | | |
| Vansil ® HR2000 | 19.55 | 18.71 | 17.93 |
| CAB-O-SIL ® TS 720 | 3.76 | 3.60 | 3.45 |
| H3PO4 85% | 9.02 | 12.95 | 16.55 |
| Total | 100.00 | 100.00 | 100.00 |

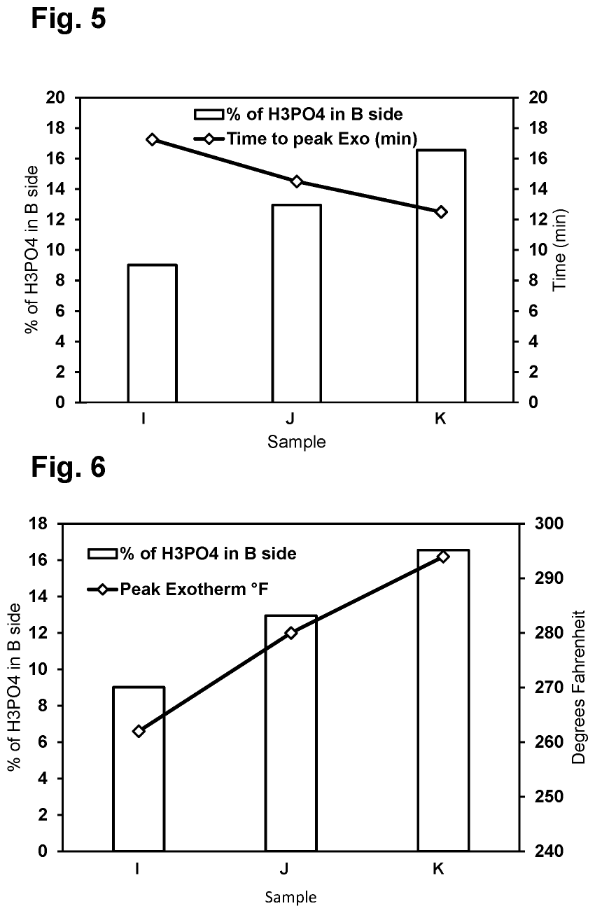

FIG. 5 illustrates a graph. The graph illustrates the time it takes to reach the peak temperature of the exothermic curing reaction as a function of the ratio of phosphoric acid in the B-side formulation. The time it takes to arrive at the peak temperature of the exothermic reaction generally decreases as the ratio of the phosphoric acid in the B-side increases. Peak temperature of the exothermic reaction was determined consistent with ASTM D2471-99.

FIG. 6 illustrates a graph. The graph illustrates the peak temperature of the exothermic reaction as a function of the ratio of phosphoric acid in the B-side formulation. As the ratio of the phosphoric acid in the B-side increases, generally the peak temperature of the exothermic reaction increases. Peak temperature of the exothermic reaction was determined consistent with ASTM D2471-99.

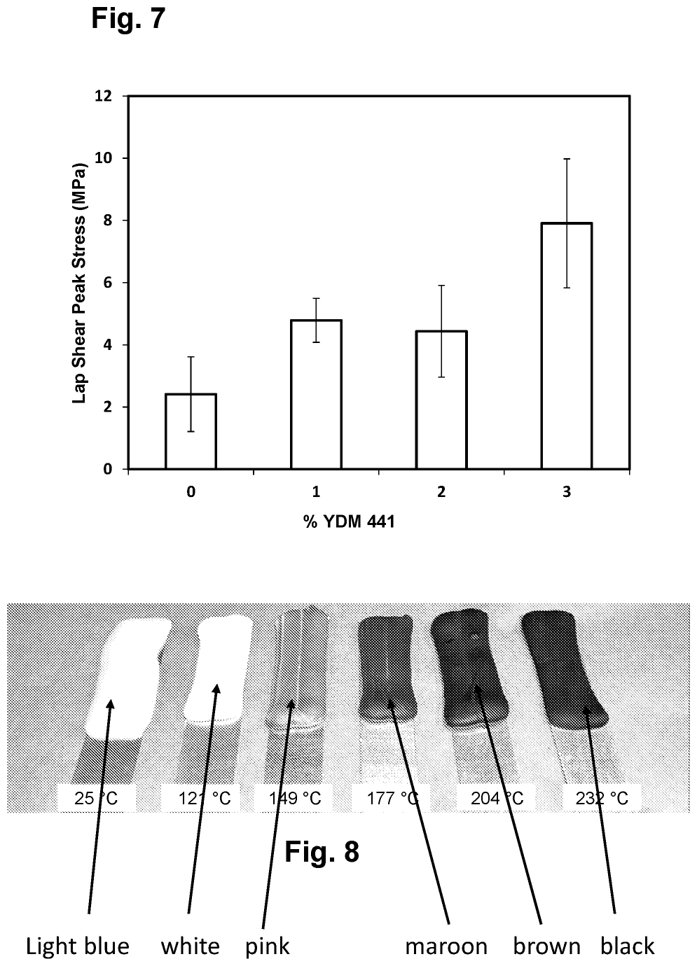

FIG. 7 illustrates a graph. The graph illustrates the lap shear peak stress as a function of the ratio of reactive color-change agent in the formulation. As the ratio of reactive color-change agent increases, the lap-shear peak stress generally increases. Lap-shear testing may be performed according to ASTM D3163-01.

FIG. 8 illustrates reaction products exposed to various temperatures. The reaction products were exposed to the specified temperature for about 30 minutes. The light blue color of reaction product cured at room temperature, changes slightly when post-cured at about 121° C. The color of material changes to a light brown when exposed to 149° C. The color of material changes from light brown to brown at about 117° C. The color of the material changes from brown to dark brown at about 204° C. The color of the material may change from dark brown to dark brown/black at about 232° C.

The intensity of color change at elevated temperatures may depend on the ratio of the reactive color-change agent in the A-side. Table 3 shows the formulation of the reaction products illustrated in FIG. 3.

TABLE 3

| | g |
|---|---|
| Part A | |
| D.E.N. ™ 426 | 43.39 |
| Erisys ® GE 60 | 13.01 |
| Kene Ace MX-257 | 13.01 |
| Hubercarb ® Q325 | 5.20 |
| Vansil ® HR2000 | 21.70 |
| Epotec ® YDM 441 | 3.55 |
| Garamite-1958 | 0.14 |
| Total | 100 |
| Part B | |
| Cashew nut shell liquid -based | 18.38 |
| phosphate ester | |
| Phenyl glycidyl ether -based | 64.33 |
| phosphate ester | |
| CAB-O-SIL ® TS 720 | 2.75 |
| H3PO4 85% | 13.34 |
| Garamite-1958 | 1.20 |
| Total | 100 |

Table 4 shows exemplary formulations where small amounts of non-reactive color-change agents were used. The non-reactive color-change agents are pH sensitive. The non-reactive color-change agents may change the color of the mixture of the A-side and the B-side. All quantities are provided in units of grams.

TABLE 4

| | L | M | N |
|---|---|---|---|
| A Side | | | |
| D.E.R. ™ 331 ™ | 13.77 | 13.77 | 13.77 |
| Epalloy ® 8250 | 25.71 | 25.71 | 25.71 |
| Erisys ® GE 60 | 12.86 | 12.86 | 12.86 |
| Kane Ace MX-257 | 18.37 | 18.37 | 18.37 |
| Epokukdo KSR 177 | 4.59 | 4.59 | 4.59 |
| Carboxyl-terminated epoxy/elastomer | 2.75 | 2.75 | 2.75 |
| adduct | | | |
| Hubercarb ® Q2 | 0.95 | 0.95 | 0.95 |
| Hubercarb ® Q200 | 2.10 | 2.10 | 2.10 |
| CAB-O-SIL ® TS 720 | 1.19 | 1.19 | 1.19 |
| NYGLOS ® 8 | 17.70 | 17.70 | 17.70 |
| Cresol Red | 0.10 | 0.00 | 0.00 |
| Crystal Violet | 0.00 | 0.10 | 0.00 |
| Total | 100.00 | 100.00 | 100.00 |
| B Side | | | |
| Cashew nut shell liquid -based | 15.81 | 15.81 | 15.81 |
| phosphate ester | | | |
| Phenyl glycidyl ether -based phosphate | 55.34 | 55.34 | 55.34 |
| ester | | | |
| Vansil ® HR2000 | 18.97 | 18.97 | 18.96 |
| CAB-O-SIL ® TS 720 | 3.56 | 3.56 | 3.56 |
| Bromocresol Green | 0.00 | 0.00 | 0.10 |
| H3PO4 85% | 6.32 | 6.32 | 6.32 |
| Total | 100.00 | 100.00 | 100.00 |

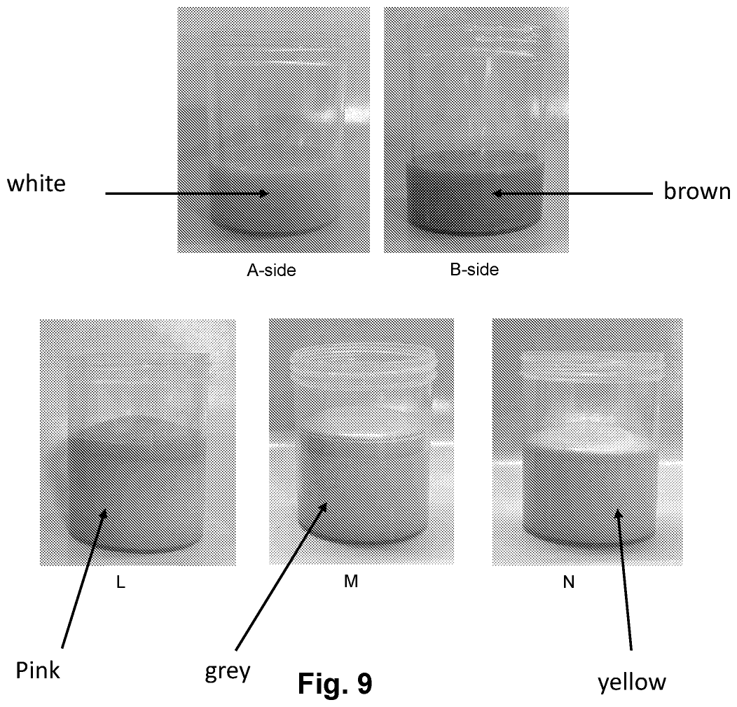

FIG. 9 illustrates the color change effect of including non-reactive color-change agents in the two-part system. The A-side and the B-side are shown in the top row. The colors of the unmixed A-side and the B-side are the same for samples L, M, and N. The A-side is tan, and the B-side is brown. The small quantities of non-reactive color-change agents added to each sample according to Table 4 provides approximately no change to the original colors of the A-side and the B-side.

The mixed A-side and B-side products for each sample are shown in the bottom row. The colors of the mixed products are different as a result of the non-reactive color-change agents provided and the pH change effectuated by mixing the A-side and B-side. Sample L turned pink, sample M turned to light blue/gray, and sample N turned yellow. None of these colors would have been expected from the combination of a tan material (A-side) with a brown material (B-side).

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time, and the like is, for example, from 1 to 90, from 20 to 80, or from 30 to 70, it is intended that intermediate range values such as (for example, 15 to 85, 22 to 68, 43 to 51, 30 to 32, etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints.

As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

The disclosures of all articles and references, including patent applications and publications, are incorporated by reference for all purposes. Other combinations are also possible as will be gleaned from the following claims, which are also hereby incorporated by reference into this written description.

1. A color-changing two-part system comprising:
an A-side; and
a B-side comprising one or more acids;
wherein a reactive color-change agent is present in the A-side; a non-reactive color-change agent is present in the A-side and/or the B-side; or both.

2. The two-part system according to claim 1, wherein the reactive color-change agent includes an aniline derivative selected from chloroanlines, methylanilines, and chloromethylanilines.

3. The two-part system according to claim 1, wherein the reactive color-change agent includes a 4,4′-methylenedianiline derivative.

4. The two-part system according to claim 1, wherein the reactive color-change agent is epoxidized such that the reactivity is based upon an epoxy functional group.

5. The two-part system according to claim 4, wherein the reactive color-change agent is 4,4′-methylenedianiline tetra-glycidyl ether.

6. The two-part system according to claim 4, wherein the reactive color-change agent is present in the A-side in an amount of between about 0.1% and 30%, more preferably between about 1% and 25%, or even more preferably between about 5% and 20%, by weight of the A-side.

7. The two-part system according to claim 1, wherein one or more color change agents are pH sensitive.

8. The two-part system according to claim 7, wherein the non-reactive color-change agent provided in the A-side includes Cresol Red, Crystal Violet, or both.

9. The two-part system according to claim 7, wherein the non-reactive color-change agent is present in the A-side in an amount of between about 0.05% and 5%, more preferably between about 0.1% and 3%, or even more preferably between about 1% and 2%, by weight of the A-side.

10. The two-part system according to claim 1, wherein the non-reactive color-change agent provided in the B-side includes Bromocresol Green.

11. The two-part system according to claim 7, wherein the non-reactive color-change agent is present in the B-side in an amount of between about 0.05% and 5%, more preferably between about 0.1% and 3%, or even more preferably between about 1% and 2%, by weight of the B-side.

12. The two-part system according to claim 1, wherein the A-side comprises one or more additional epoxy resins preferably including one or more multifunctional aromatic epoxy resins, multifunctional aliphatic epoxy resins, epoxy novolac resins, silane modified epoxy resins, or any combination thereof.

13-17. (canceled)

18. The two-part system according to claim 1, wherein the two-part system, after mixing the A-side and the B-side, expands to a volume of between about 10% and 800%, more preferably between about 50% and 700%, or even more preferably between about 100% and 600% of the original unexpanded volume of the A-side and the B-side.

19. The two-part system according to claim 1, wherein the A-side consists essentially of the reactive color-change agent.

20. The two-part system according to claim 1, wherein the one or more acids comprise at least one or more phosphate esters and optionally phosphoric acid, citric acid, acetic acid, other acidic phosphorous compounds, or any combination thereof.

21. The two-part system according to claim 20, wherein the one or more phosphate esters include cashew nut shell liquid-based phosphate esters, 2-ethylhexyl glycidyl ether-based phosphate esters, phenyl glycidyl ether-based phosphate esters, or any combination thereof.

22-24. (canceled)

25. The two-part system according to claim 20, wherein the two-part composition is a thermoset.

26. The two-part system according to claim 1, wherein a color of the mixed A-side and B-side is not a color that would be expected based on color theory from a mixture of the original color of the A-side and the original color of the B-side.

27. The two-part system according to claim 20, wherein the pH of the A-side is about 5 to 10.

28. The two-part system according to claim 27, wherein the pH of the B-side is less than 7.

29-70. (canceled)
